(19) United States
(12) Patent Application Publication
(10) Pub. No.: US 2002/0046053 A1
(43) Pub. Date: Apr. 18, 2002

(54) Web based risk management system and method

(75) Inventors: Kai Tamara Hare, San Francisco, CA (US); James Mullarney, San Francisco, CA (US)

Correspondence Address: REED SMITH LLP, 375 PARK AVENUE, NEW YORK, NY, 10152, US

(73) Assignee: NuService Corporation

(21) Appl. No.: 09/935,141

(22) Filed: Aug. 21, 2001

Related U.S. Application Data
(60) Provisional application No. 60/229,676, filed on Sep. 1, 2000.

(51) Int. Cl. G06F 17/60

(52) U.S. Cl. 705/1; 707/200

(57) ABSTRACT

A web based system maintained at a central server and accessible to users over the Internet for defining financial risks and risk mitigation needs of a user based upon profile data of the user. The system includes a means for inputting user profile data into the system; means for accumulating the input data in databases to enable analysis of said data; and means for analyzing the profile data and for identifying financial risks associated with said profile data. The system also provides a means for identifying financial products which will provide solutions to mitigate such risks as well as a means for specifying the cost to acquire or purchase those financial products. Finally the invention includes means for binding in real time a commitment for the purchase and sale of financial products; and a means for processing a transaction to implement the purchase and sale of the financial products.

### CROSS REFERENCE TO RELATED APPLICATIONS

The application hereby incorporates by reference the contents of and claims priority to U.S. provisional application Ser. No. 60/229,676 filed Sep. 1, 2000.

### FIELD OF THE INVENTION

This invention relates generally to the field of risk management and more particularly to a web based system and method for defining the risk mitigation needs of a user or client, for formulating a program to identify solutions for such needs and to create recommendations for financial products and related solutions (such as for example futures, options, insurance, long term investments, future currency contracts, etc.) to meet such needs. The invention has the means for the preparation of premium or price indications and quotations for such products, as well as the ability to bind in real time and for the ultimate issuance of the financial products consistent with the recommended solutions. The system further has the ability to process and transact the purchase of insurance and other financial products. The program is implemented in accordance with client data inputted into the system.

### BACKGROUND OF THE INVENTION

The creation of a risk management program and a financial portfolio is often a difficult and complex process. Significant assessment is usually required to understand the risks associated with a particular business entity and to identify appropriate solutions for the mitigation of such risks. Collection of necessary data required to assess business activities in order to define risks for any particular business entity is a difficult and time-consuming process. In addition, once appropriate data is collected, the process of comparing that data to existing databases in order to provide recommended solutions for risks identified from such data is also a complex and complicated process. Many factors are required to determine the type of solutions (whether they be insurance or other investment solutions such as futures, options, future currency contracts, etc.), as well as the many types of risks to be mitigated. While it has heretofore been common to use a computer based system to assist risk managers, financial advisors, insurance brokers or agents to collect data and to prepare necessary information for a client to evaluate, as well as for maintaining accurate records, the graphical user interface (“GUI”) needed for a particular computer system to perform these tasks may vary greatly depending upon the risk mitigation solutions under consideration. Frequently, there are numerous screens on a computer program available for each type of product. Further, there are numerous variables that determine a client's needs to mitigate risks, assessment of the size of the risk and appropriate solutions for such risks. People responsible for managing risk have not heretofore had available a web based solution that will enable such managers to quickly and effectively identify risks, analyze the risks and provide the means for access to sources that will provide appropriate solutions to mitigate the risks by the use of, for example, customized financial products.

### OBJECTS OF THE INVENTION

It is therefore an object of the invention to provide a web based system and method which is accessible over Internet protocols to facilitate the identification of financial products to mitigate risks and for facilitating the purchasing of such products on line. The system and method of the present invention enables risk managers, such as Chief Financial Officers or other persons in a business entity responsible for the risk management function, to identify risks unique to their business activity, to identify products and solutions for the identified risks, to design unique products and solutions specific to their risks and to provide such solutions in real time to the end users. The system of the present invention, sometimes referred to herein as the nuServe system, is directed at defining the solutions to the identified risks. By way of example, insurance products are discussed herein as one such solution.

Another object of the invention is to provide a system and method as a means for accelerating real time delivery of financial products and services by enabling transactions and communication among suppliers of such products through the nuServe system as a hub facility.

Other objects, features and advantages of the invention will be apparent to those skilled in the art after appreciating the invention from the description below.

### BRIEF SUMMARY

The invention is accordingly characterized by a process carried out by the nuServe system, which is referred to herein as the nuServe process. The nuServe system and process is made available to users, such as persons responsible for managing risks, by having access to a web site (the “nuServe web site”) that maintains the system. The nuServe web site enables operations of the nuServe process and incorporates programs or engines referred to as the iSolve and QSolve engines. The iSolve engine generally provides the function of computing various financial product values and prices/premiums of different lines of business or types of coverage required by the user. The QSolve engine will generally be used for providing quotations of premiums for only a particular line of business or insurance coverage. The iSolve engine enables the user to understand particular risks, thus, enabling management of such risks, to identify known or unmet exposure to risk and the ability to analyze such risk and exposure to risk. The iSolve engine then provides solutions to mitigate such risks and exposure to risk through the use of customized risk management solutions. By access to the nuServe web site, a user can employ iSolve to enable customers to identify and select financial products of particular suppliers most suitable to the customers' needs. The iSolve engine includes filters for matching the needs of a user to the criteria of a financial product supplier. Such a user may, for example, be an insurance company, an insurance broker or a risk manager, who might be the Chief Financial Officer, of a business entity. An insurance broker for example, would use iSolve to expedite the identification of the best insurance products or solutions to fit a customer's particular needs, and to provide premium quotations for such products or solutions, and to bind such products in real time. Insurance companies (companies that issue insurance policies) or insurance brokerage firms may also participate through the nuServe process. Purchasers of financial products which have been identified to mitigate the purchasers' identified risks will have access to such companies and firms based upon the solutions to that purchaser's profile requirements.

To begin the process, a user first creates a unique risk profile using a program that extracts customer data in a graphical format to build a specific risk profile. The program, referred to as “Profiler” is accessed once a user is on the nuServe web site and has logged in and registered with the nuServe system. Because insurance products may provide one solution, Profiler also prepopulates a universal insurance application, which in part completes multiple monoline applications, to enable the provision of multiline insurance indications.

The GUI for the Profiler is used to extract customer data in a graphical format to build the specific risk profile. The data acquired through this process identifies specific risk management needs particularly for small and medium sized businesses. Indications will be provided as to the lines of business risks required to be considered, appropriate endorsements and financial product limitations, as well as initial ballpark price or premium levels. The system will provide the user with the ability to conduct a cost-benefit analysis of what is currently insured, against what is uninsured. A transaction link enables the user to bind on-line through the nuServe web site in real time.

The system of the invention includes a GUI that enables persons responsible for managing risks to navigate the process and identify customized risk needs. The data supplied will identify risk needs and will populate multiple databases enabling calculation of financial product limits and premium or price indications. The system also utilizes communications links to other systems of brokers, insurance agents, insurance companies, suppliers of other financial products as well as to appropriate data feeds. The system uses known programming languages and databases as well as uniquely designed scripting language to implement the process.

Accordingly, the invention provides a web based system maintained at a central server and accessible to users over the Internet for defining risk mitigation needs of a user based upon profile data of the user, and includes means for inputting profile data into the system, means for accumulating and saving the data in databases to enable analysis of that data, and means for analyzing the profile data and for identifying financial risks correlated to that profile data. The system also includes means for identifying financial products which provides solutions to mitigate such risks, and means for indicating the cost to acquire or purchase those financial products. Finally, the invention includes means for matching the needs of a user to a supplier of financial products and for binding in real time a commitment for the purchase and sale of the financial products, and means for processing a transaction to implement the purchase and sale of the financial products.

The invention also provides for a process to define such risk mitigation needs, which includes the steps of inputting the user's profile data into the system of the invention, accumulating and saving the data in databases to enable analysis of the data, analyzing the data and identifying financial products which provide solutions to mitigate the risks. The process of the invention also includes indicting the cost to purchase the financial products for matching needs of a user to resources of a financial products provider, and for binding a commitment. Processing a transaction to implement a sale of the financial product is also part of the process of the invention.

The foregoing and other features of the present invention are more fully described with reference to the following drawings annexed hereto.

### BRIEF DESCRIPTION OF THE DRAWINGS

FIG. 1 is a flow chart illustrating the process of the present invention;

FIG. 2 is block diagram illustrating the overall architecture of the system of the present invention;

FIG. 3 is a flow chart of the registration process used in the present invention;

FIG. 4 is a flow chart of the iSolve processing step of the invention;

FIG. 5 is another flow chart of the iSolve processing step in greater detail;

FIG. 6 is a flow chart of the QSolve processing step of the invention;

FIG. 7 is a flow chart of the purchasing step of the QSolve process;

FIG. 8 is a block diagram illustrating functions of the calculator used in the invention;

FIG. 9 is a flow chart of the service processing steps of the invention; and

FIGS. 10-18 are flow charts illustrating functional flow diagrams of scenarios of activities for the following steps respectively: login; registration; profile generation; iSolve1 processing; iSolve2 processing; iSolve3 processing; QSolve1 processing; QSolve2 processing and QSolve3 processing.

### DESCRIPTION OF THE PREFERRED EMBODIMENT

nuServe Processes

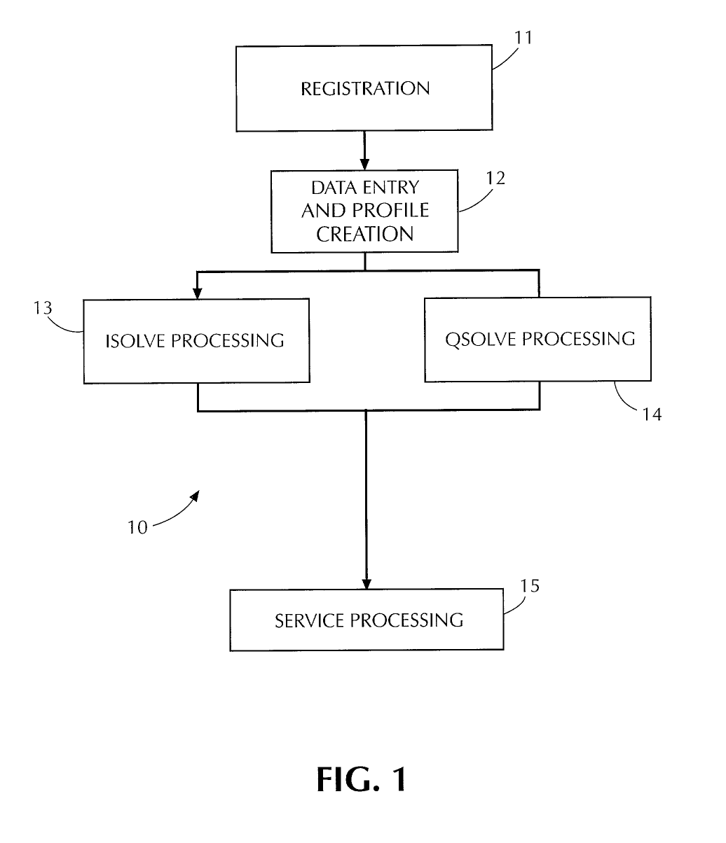

The overall process 10 of the invention (sometimes referred to as the “nuServe process”), as illustrated in FIG. 1, involves the following principal steps which are described in more detail below: Registration—11; Input Data Entry—12; iSolve Processing—13; QSolve Processing—14; and Service Processing —15.

When using the present invention, a user will navigate over the Internet to the web site where the process of the invention is accessible (the nuServe web site). After a user logs on to the site, the first step in the use of the process will be registration of the user. As noted below, a user may register in a variety of categories which will determine the level of services available to that user. The next step in the process will be the data entry step 12, described more fully below, and generally requiring the input of data to the system for storage in the databases of the system for future reference, analysis, and calculations. iSolve processing occurs at step 13 and involves the use of the iSolve engine in order to examine the input data stored in the database for analysis and for identification of the financial risks associated with the profile of the user as indicated by the data entered, as well as for identifying financial products to provide solutions for such risks. As noted above, iSolve processing using the iSolve engine provides the capability of computing financial product values, prices and premiums for different categories of risk (sometimes referred to herein as “lines of business”). The QSolve processing step 14 is used to accomplish the function of specifying the cost to acquire the identified financial products or to provide quotations and premiums for insurance or other financial products for a particular risk category, i.e. a single line of business. The service processing step 15 includes such functions as updating the user's profile, comparing the profile to a generated portfolio, generating binder and certificate forms, and file transfer, all of which are discussed more fully below.

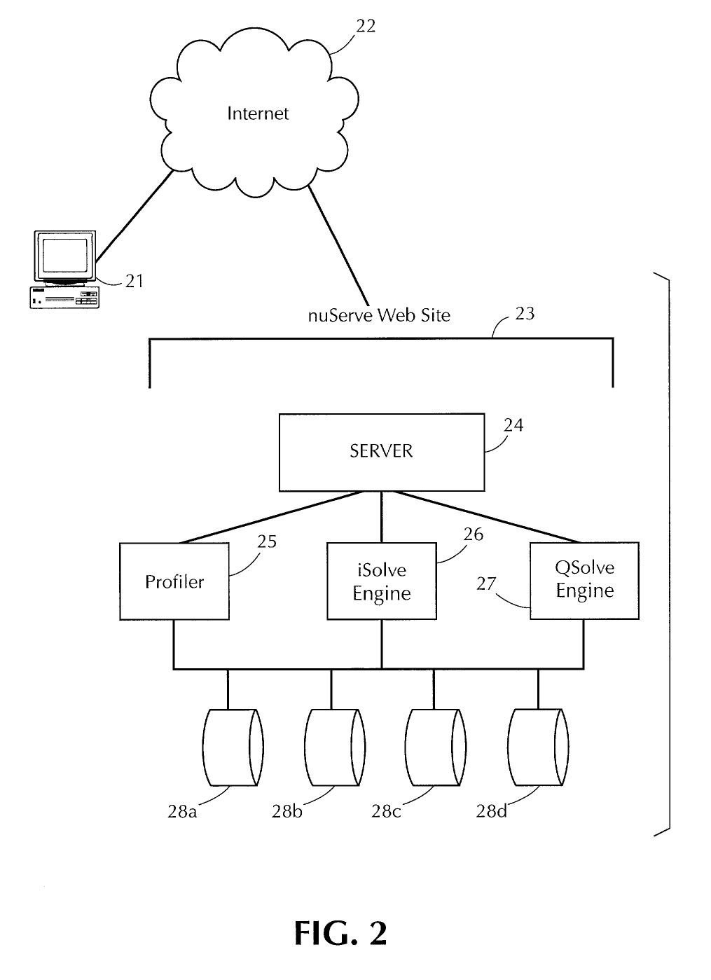

These steps of the nuServe process are generally carried out on the nuServe system, the overall architecture of which is illustrated in FIG. 2. A user, operating through a computing device, such as desktop computer 21 accesses the nuServe web site 23 through the Internet 22. The web site 23 is hosted on a server 24 that supports the GUI for data entry to the Profiler 25 as well as the iSolve and QSolve engines 26 and 27 respectively used for data analysis, identification of financial products and price quotations. User data is entered to Profiler 25 through the GUI and stored on one or more databases 28a, 28b, 28c, 28d, etc., from where the data will be accessible to the iSolve and QSolve engines.

Registration

As noted above, user registration is the first step in the nuServe process. A user can register as a “Client”; a “Business”; a “Referral Customer”; or as an “Administrator and Other Staff”.

The type of registration will define the type of services that a user can receive. For example, a user with a formal registration as a Client, Business or Referral Customer should be able to use all of the services offered by the nuServe system, while a guest user without a formal registration may only be granted access to a partial list of services, such as using the GUI for Profiler data entry and iSolve processing. A registered user can never have access to the type of services that an administrator is granted. A registered user can access portal services such as reviewing news items, insurance related regulations, etc. which will be posted from time to time on the nuServe web site. A broker referred by an insurance company (registered as a Business) will have access to the many functions that other registered users have access to. Unlike the other users, a Referral Customer is required to enter a code, which indicates the customer's association with an insurance company. Such an insurance company might have special arrangements with the operator of the nuServe system.

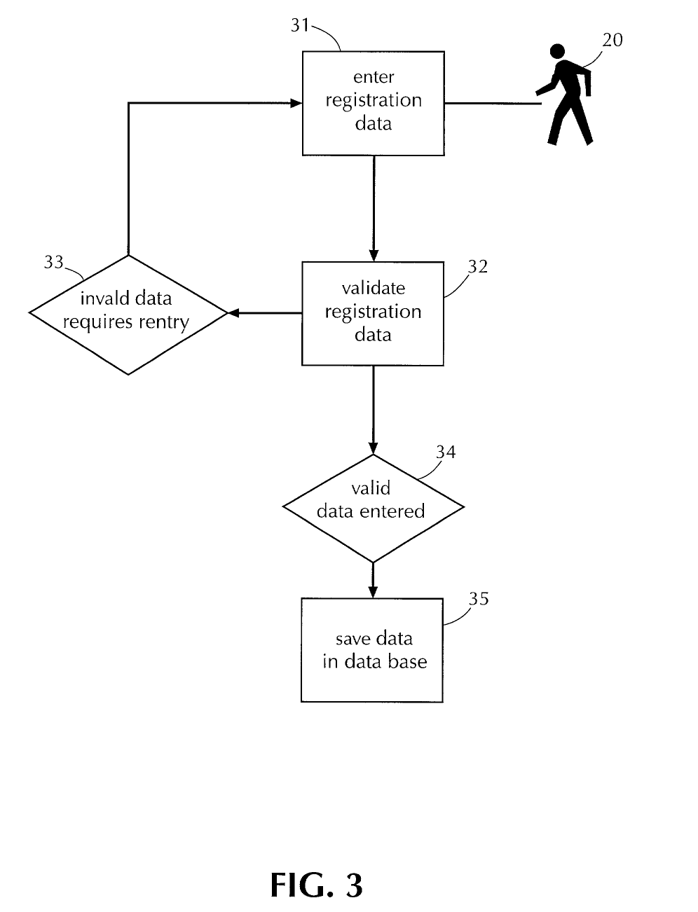

The registration process is illustrated in FIG. 3 where a user 20 enters his registration information at step 31 into the appropriate fields displayed after log-in. The data is then reviewed by a security manager on the system server at the validation step 32. The data is either determined to be invalid data, and step 33 feeds this back to the user so that data can be reentered, or it is determined to be valid registration data at step 34 and it is then saved in a database at step 35.

Input Data Entry Process

The input data entry process (or Profiler Process) 12 for the system of the invention will follow a “pull” concept. That is, the user or client will be asked to enter data for a line of insurance if the user is interested in that line of business. Furthermore, the input data entry will be in phases. New users will be presented a GUI interface for data entry. By clicking the mouse at different parts of the screen different icons will pop up. For instance, a land icon would require the user to enter input data that is related to his property. This data will be entered into the appropriate fields appearing on the screen related to property. An auto icon popping up in another part of the screen would require the user to enter input data on the autos owned or leased by the user. This data can be entered into fields on a screen which will be presented by clicking on the auto icon. If an icon is of no interest to the user, he/she may choose to discard it. The user continues GUI input entry until the whole screen is filled up with different icons or until the user stops it at some point in time. In either case, the data collected from the user by entry into the appropriate fields on the GUI screen will be stored in the databases from which a user profile is created.

The input data entry could potentially be a three-phase process. The first phase of the input data entry process is described above. The information collected in the first phase is what is required to run the iSolve engine 26 or the QSolve engine 27. Should the user decide to eventually purchase insurance or other financial products, a second phase of data entry is used where more input data will be required at the time of actual quotation. A third phase of data entry will again be required at the time of actual purchase of an insurance policy. However, the user will not be asked for these additional data until the right time in the process.

Since QSolve processing is for quick quotes on a single line of business, it naturally requires less data compared to the amount of data required for the iSolve engine to complete its processing.

Profiler—User Input Data

Upon the completion of the data entry using Profiler, the user links to a “Profiler Page” where the Profiler data will be retrieved from the databases and presented on the user's display screen. This page is a separate page from the GUI used to populate Profiler, and which was used for input data entry. The Profiler Page will be encrypted and can be used for data mining and analysis of user profiles. Because this page has significant commercial value in terms of customer data, it will be stored with a high degree of security. If the user is a non-registered guest, then its profile data together with its GUI, which includes the input data, will be stored in the databases. A guest user will be asked to enter a guest ID which will be used as an access key to the stored information. The databases will only store this information for a predetermined period of time. The guest user will be notified of this time limit.

iSolve Process

Profiler Page includes a link (which could be labeled “Get my profile”) to the iSolve engine 26. The iSolve process can then be used to compute limits and premiums for various lines of business. The iSolve engine is programmed to accept data, evaluate risks and recommend financial solutions for a variety of categories of business risks, sometimes referred to as “lines of business” or “LOB”. Examples of such business risks that the iSolve engine can address include: Property and Business Income; Crime Coverage; Fiduciary Liability; General Liability; Boiler and Machinery; Errors and Omission Liability; Commercial Auto; Employment Practices Liability; Directors and Officers Liability; Workers Compensation; Umbrella/Excess Liability; KNR; Earthquake and Flood; Transit and Ocean Marine; Cyber Liability; Environmental Impairment Liability; and BOP.

Depending on the extent of the input data received from the user, the iSolve engine 26 will compute insurance limits and premiums on policies that mitigate these business risks. These can be categorized into the following major categories: Property; Liability; Auto; Worker Compensation; and Others.

The iSolve engine utilizes average insurance rates, established by the Insurance Service Office (ISO), incorporated and stored in the databases for the calculation of the limits and premiums.

Each category may consist of several lines of business or categories of business risks. These, together with the insurance limits and premiums for policies, or other financial products for mitigating those risks, will be tabulated on the Profiler Page generated by the iSolve engine. The Profiler Page will also include a button which the user can click on to have the iSolve engine “Update My Risk Profile”; and “Compare iSolve to my Current Portfolio.”

The iSolve processing step 13 is based upon the data entry step 12 and the user Profile which is generated by that processing step. iSolve processing is then accomplished in three stages or phases: The first phase (referred to as iSolve1) is a computational process; the second phase (referred to as iSolve2) is the quotation phase; and the third phase (referred to as iSolve3) is the purchasing phase.

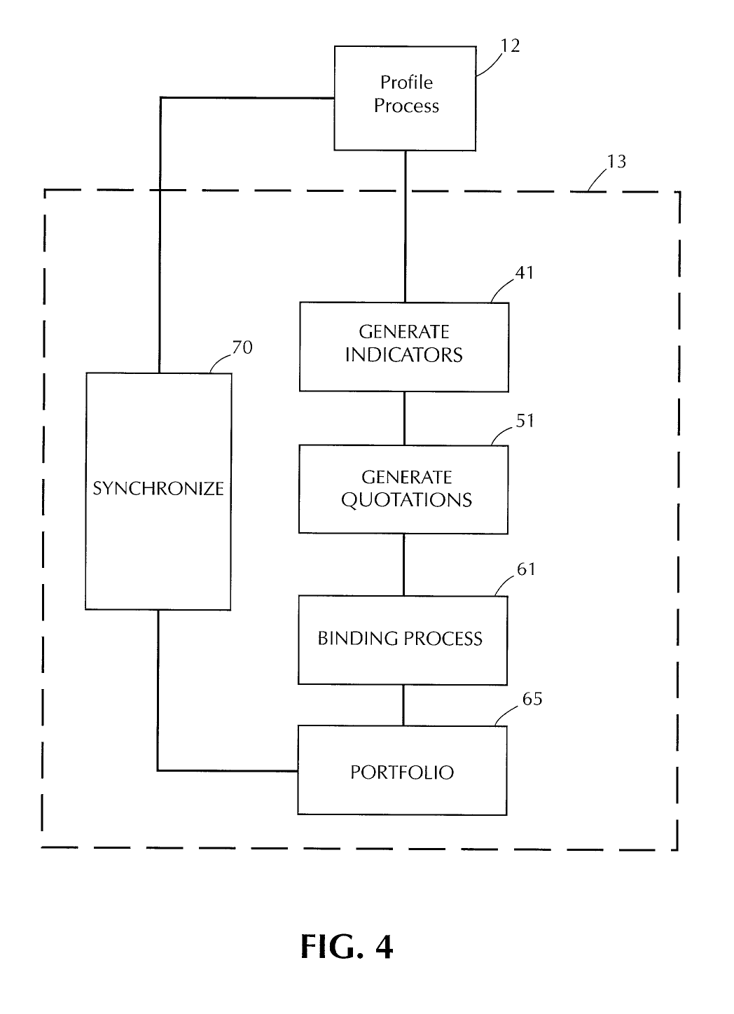

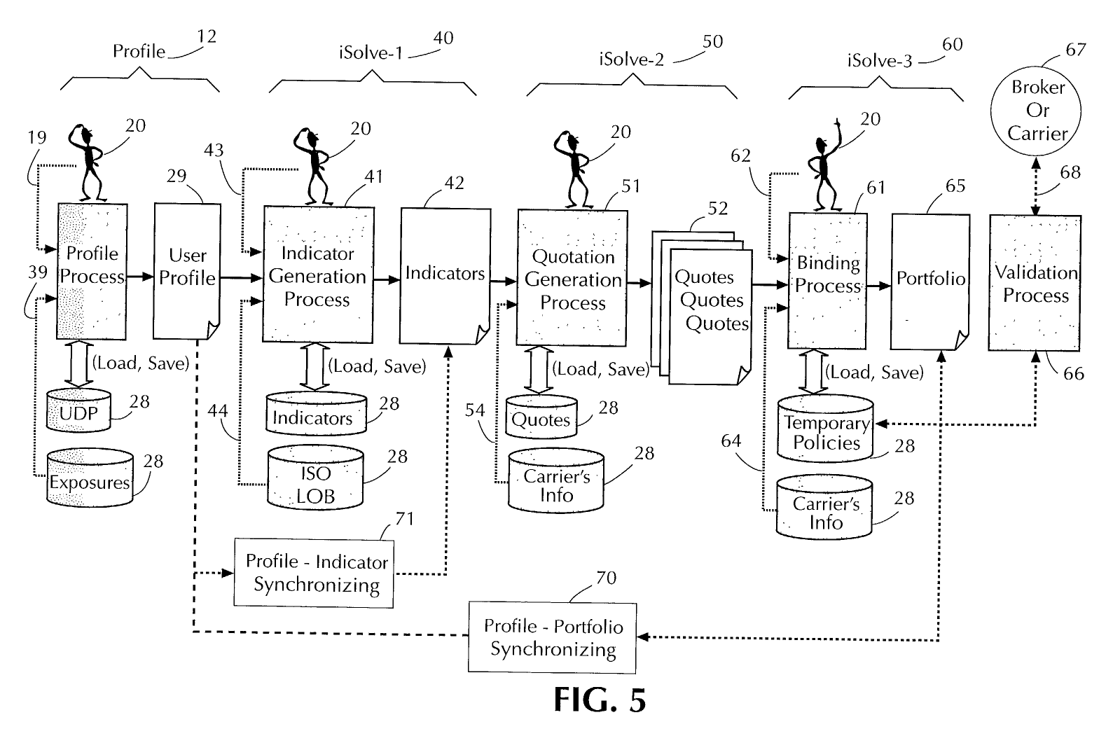

The overall iSolve process is generally indicated on FIG. 4. After the profile process of step 12 is completed the iSolve1 step 41 is the computational process resulting in the generation of indicators (discussed below). These indicators are then used at the iSolve2 step 51 (the second phase) for the generation of quotations or prices for the possible purchase of financial products to mitigate the assessed risks. Phase three (iSolve3) of the iSolve process is completed at step 61, which is the binding process or the purchasing phase. The purchasing phase results in the creation of a portfolio 65. The details of the portfolio may contain information which will impact the user profile and therefore synchronization step 70 feeds back the portfolio information to the profile process 12 for possible redefinition of the profile. This will automatically result in recalculation of the indicators at step 41 and regeneration of quotations at step 51. These phases of the iSolve processing step 13, and the overall life cycle for the iSolve processing step is described herein below in greater detail in connection with FIG. 5.

The Profiler process 12 includes data entry 19 by user 20, saving the input data to the databases 28, and creating a user Profile 29 (displayed on the Profile Page) which includes risk exposures supplied at 39 from the databases. The computational phase 40 (iSolve1), includes an indicator generation step 41, to generate indicators 42 using computational models mapped into flow models and based on inputs 43 from the user 20 and inputs 44 from the databases including ISO rates, LOB's, stored indicators etc. Generated indicators 42 consist of policy premiums and policy limits depending on and related to the risk exposures. These indicators are obtained based on average ISO rates for different risks or LOB's stored in the databases. After reviewing the generated indicators, the user may decide to obtain actual quotations from insurance companies. iSolve2, the second phase 50, commences at this point and consists of a quotation generation process 51 which generates a set of quotes 52, from the databases 28 or from a third-party vendor, such as an insurance carrier or broker who will have received data about the user from the databases 28 and provides this information 54 to the quotation generation process.

The user has the ability to select quotes for all, some or only a single line of business based on that user's profile. Thus, the user can select “Quote all lines of business”; “Quote some lines of business”; or “Quote”. The “Quote” option will lead the user to the same process as QSolve for quoting a single line of business (discussed in more detail below).

Depending on the selection of the user, there will be some additional input data requirements. For the first two options above, a computational (sort and search) engine will determine the optimal product line for each line of business. For instance, for a first line of business, the engine will provide the user with the option of choosing a particular insurance provider. For a second line of business, the search engine will select the same or some other provider. In theory the search engine should be performing multi-line or multi-objective (taking into account multiple lines of business) optimization. This, however, depends on information from insurance carriers. The optimization routine will consider all applicable carriers for a line of business. For specific cases, such as PIZZA program, the product line will be privately labeled, thus restricting the optimization.

As noted above, two possibilities exist for the outcome of using the iSolve2 process 50: (i) quotations will be provided from the database; or (ii) quotations will be received from an insurance company or broker.

In the first case, the quotation generation process 51 will use a model for each line of business for each applicable insurance company (different insurance companies could have different ways of calculating the quotation for a line of business). In the second case, the nuServe system will send the required user data from its databases 28 to a selected insurance company for quotation. This can be transmitted either electronically or in hard copy.

Having the quotes 52 available, the user may decide to purchase one or more lines of business. ISolve3 process 60 (the third phase) starts here. Several options are available to the user at this point. He/she can purchase a policy, or other product on line, and the user can either purchase products to mitigate all categories of risk (LOB's) or only selected LOBs.

For each line of business that the user selects to purchase a policy for, a confirmation page (or “Contract Page”) will be provided which will include profiler data and will require additional data 62, which should be keyed in by the user (this is the third phase of input data entry). Thus the iSolve3 process includes a binding process 61, which may include a supplementary data entry step 62.

If a proposed carrier for a given line of business has an agreement with the provider of the nuServe process then a temporary policy (previously loaded and saved in the database 28) can be made online and in real time to create part of a product portfolio 65. Otherwise, the user will be notified of a delay as the request will have to be sent (path 68) to a third-party insurance carrier or to a broker. The user will also be given the option of choosing another carrier based on information 64 selected by the database 28 for which there is an agreement with the nuServe process provider and binding can be immediate. If the user decides to wait for a carrier of his/her choice, then a form (which is carrier dependent) will be prepared and will be electronically submitted after a validation process 66 to the insurance carrier or to the broker 67.

At synchronization step 70 the active Profile 29 is modified by the user if necessary and iSolve will automatically recalculate the indicators used for quotation at iSolve2. The product portfolio 65 will include information that should be considered in this recalculation. The system must know if the Profile is changed. Any changes must therefore be saved by the system. Such a save function will be implemented if the user either exits the system, specifically chooses a save function, obtains a quotation or purchases a product. At synchronization step 71 the user has the opportunity to adjust or modify the Profile after viewing the indicators by inputting updated or changed Profile data. This usually occurs as a result of the user considering “what if” scenarios or hypothetical risks. When the Profile is changed iSolve1 will recalculate the indicators. The changed Profile will automatically be saved.

QSolve Process

Should a user decide to obtain a quote for the possible purchase of and/or to purchase an insurance policy for a single LOB, the QSolve engine 27 will be the appropriate engine to use. The use of QSolve is intended for users who are familiar with various insurance policies and users who know what they want. While additional data will be required to use the QSolve process, it will not be a large amount of data. Inputting any such additional data will be through the GUI interface. However, the user will also be given the option of entering the data by simply keying the input data through an alternate simple interface.

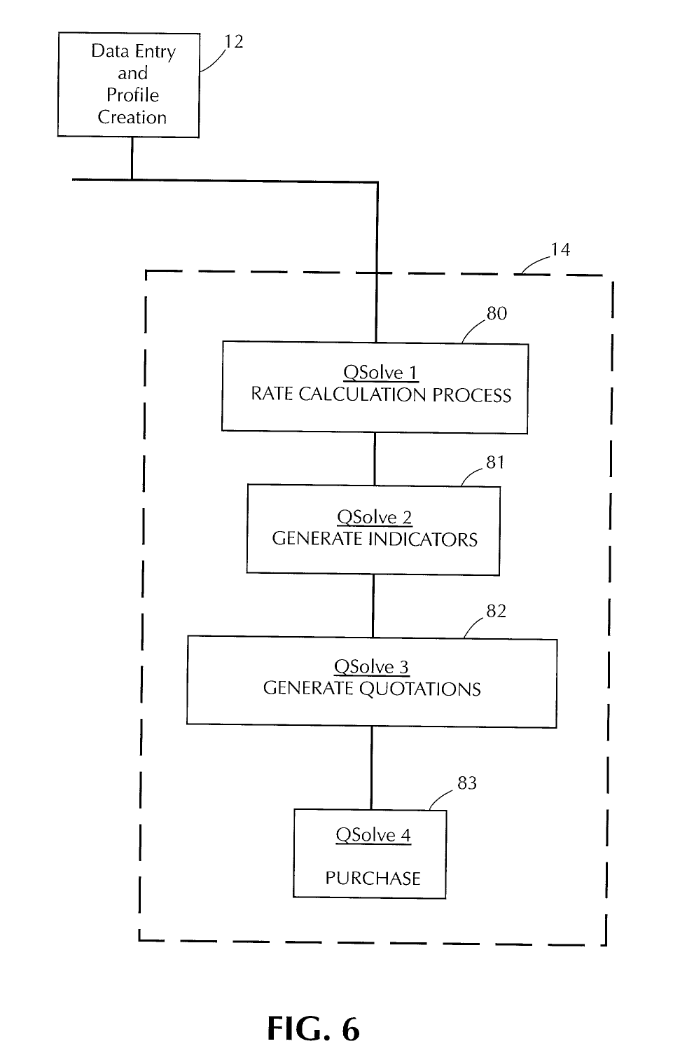

As with the iSolve process, the QSolve processing step 14 is accomplished in phases. As seen on FIG. 6 a first phase of QSolve processing, sometimes referred to as QSolve1, is a rate calculation process at step 80. This step provides a selection interface for a line of business and uses appropriate algorithms to complete the calculations. Step 81 is the second phase (QSolve2) to generate indicators (i.e. policy premiums and policy limitations). Step 82 will follow step 81 for the third phase (QSolve3) which performs the necessary calculations for generating quotations. The fourth phase, QSolve4, implements the purchasing of selected insurance policies. As will be noted, there is similarity and synergy between the iSolve processing step 13 and the QSolve processing step 14, particularly if only a single line of business is selected for quotation and/or purchasing.

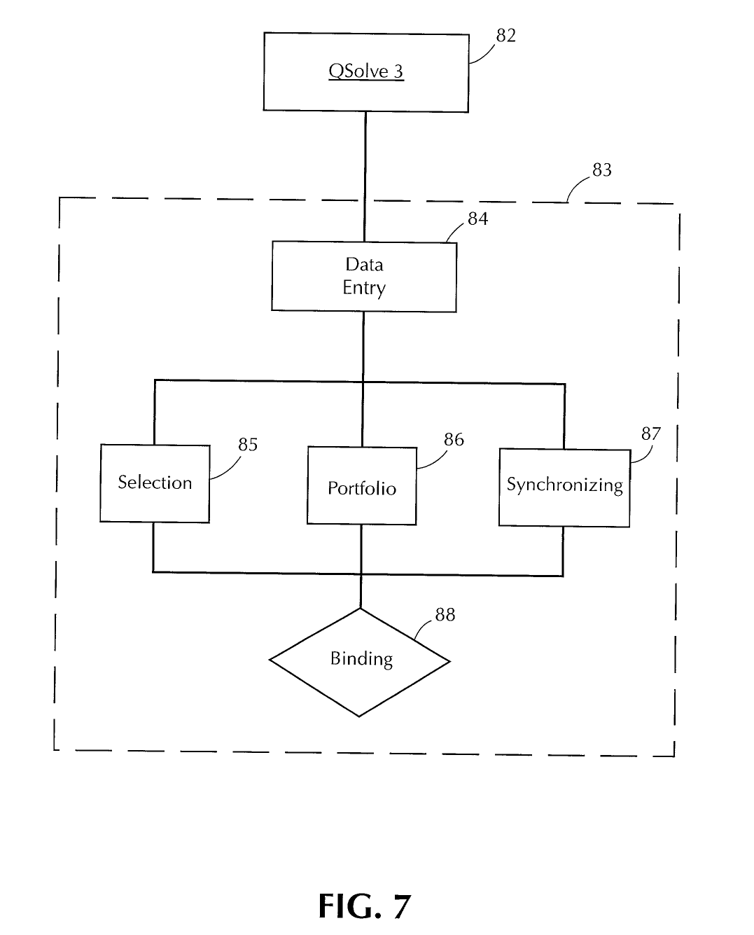

Calculating the rates at step 80 is based upon carrier rates stored in the database. Similarly, generation of the indicators at step 81 is a result of the ISO data for various lines of businesses also stored in the database. Quotation generation is also similar to quotation generation by the iSolve2 process. The final phase of purchase may require the entry of additional data for each selected carrier and can be accomplished using the GUI or via some independent data entry technique. The purchasing process consists of three parallel steps after the data entry step 84, as illustrated in FIG. 7. These are selecting to purchase step 85, policy portfolio step 86, and synchronizing step 87 for synchronizing the portfolio of step 86 with the user's original profile, in a manner similar to that discussed in connection with the iSolve processing. Completion of these steps leads to the binding step 88 for committing to the purchase and sale of the insurance product and temporary coverage.

Insurance Calculator

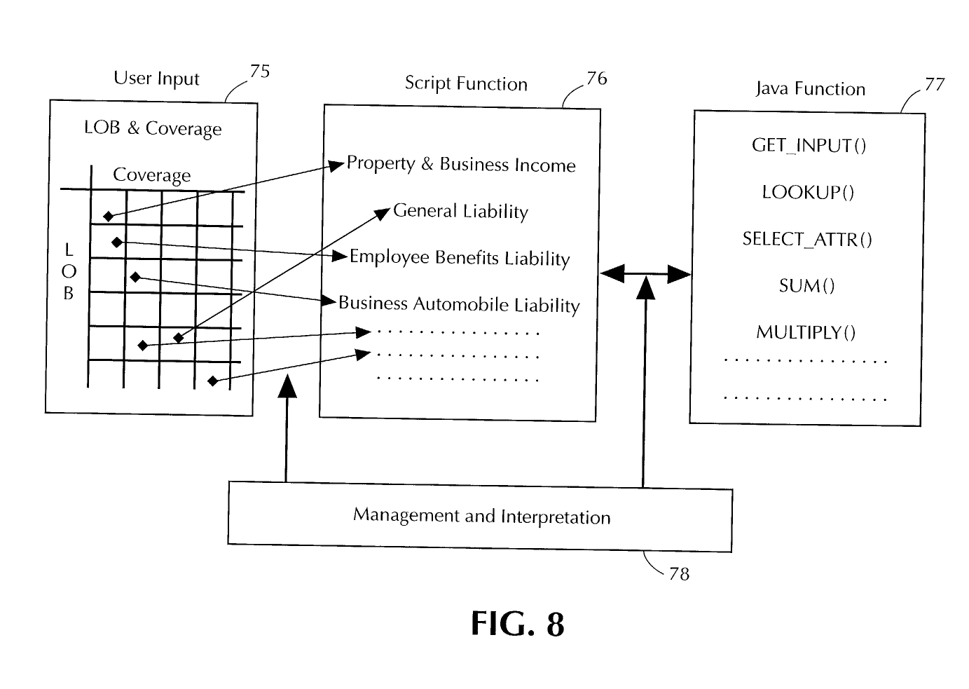

An insurance calculator is used both for computation of existing LOBs and for creating any new LOB, during the iSolve and QSolve processing. FIG. 8 illustrates the functional design of the calculator in which the User Input section 75 forms a matrix of LOB's and LOB Coverage. The Script Function 76 is in simple independent language and the Java Function 77 defines Java language for processing the script function where the management module 78 selects the computational script in view of the user input.

Service Process

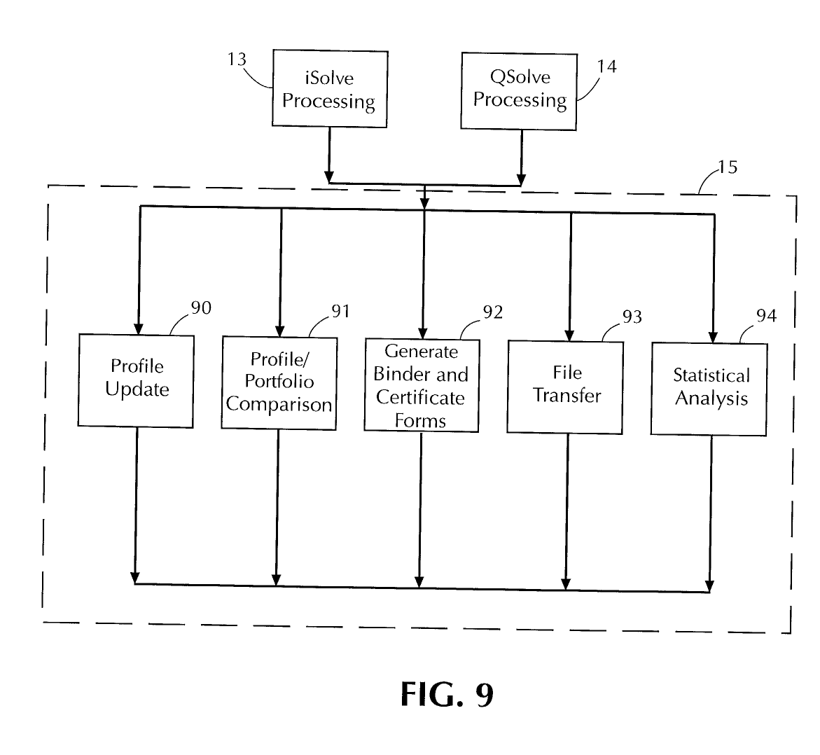

As indicated above, additional service type sub-processes, such as indicated in FIG. 9, are available, including Update the Profile process 90, Compare iSolve Profile to the Current Portfolio process 91, Generate Binder and Certificate Forms process 92, Export/Import files to/from insurance carriers and brokers process 93, and Statistical analysis and data warehousing process 94. These additional process are discussed in more detail below:

Update the Profile Process 90

After the iSolve process generates indications of the average insurance limits and premiums, the user/customer may decide to purchase insurance for the recommended lines of businesses. Should this be the case, database 28 will automatically update the insurance data (limits, carriers, premiums, etc.) for that user/customer. If the customer does not accept the recommendations generated by iSolve, then a record will be kept in the database indicating the recommendations made and the rejection by the customer.

Compare iSolve Profile to the Current Portfolio Process 91

To compare the portfolio generated by iSolve to the current portfolio of the user/customer, the current portfolio of the user will be needed if it is not already in the database. The user will be given the opportunity of downloading the data either by key boarding, or transferring the data from a commercially available program file, such as “Quicken.” It will also be possible for the user to fax in the portfolio. The fax will be scanned and stored into the database as the current portfolio. The comparison will be presented in the form of a table.

Generate Binder and Certificate Forms Process 92

There are industry standard forms that the database will store and that can be used for contract binding. Customized forms can also be used if preferred by a particular insurance carrier. Forms can be prepared and submitted to insurance carriers or brokers for approval.

Insurance Certificates are issued by a third party. A request for a certificate, however, can be generated by process 92.

File Transfer Process 93

This performs the functions associated with the export of files to carriers and brokers and the import of files from carriers and brokers. Data can be transferred either as flat files, through browser-based download using standard plug-ins (e.g. Adobe Acrobat for pdf) or through specified protocols such as XML or http. Software instruction provide the flat file transfer in both directions. The following issues for database interconnectivity will determine the required software instructions: (i) How large the volume of data is (can be measured in number of records); (ii) How often the data downloading and uploading is required to be performed; (iii) The type of database access that is provided; (iv) The logical platform to be used other than a flat file; (for example, XML, or others); (v) When using manual uploading and downloading the different types of transmission media that can be used (CD-ROM, FTP, etc.); (vi) The type of protocol for administering the database when using a dedicated server; (vii) Specific data security requirements; and (viii) The need for secure HTML or XML based Internet connectivity between database 28 and the user.

Statical Analysis Process 94

The profiler page will be linked to another page where the profile obtained from the user will be compared to the statistical data retrieved from the database on the comparable industry. Two types of analysis can be performed here: (i) analysis based on the existing industry statistics, and (ii) analysis based on the data in the system databases. Criteria for analysis will be based on SIC code, number of employees, ZIP code, and revenue. For an industry based analysis, the SIC code will be used as the only criterion for the comparison.

The analysis requires that the fields corresponding to the analysis criteria can be sorted and queried. This will ensure maximum flexibility that will eventually be required for the analysis.

Other process relating to operations of the web site and administration functions can also be carried out as part of the nuServe process.

Thee are numerous materials and functional specifications maintained in the nuServe system for implementing the nuServe process. These include LOB Process Flow models on an Excel file and different classification class codes used in the General Liability and in Workers Compensation Line of Businesses. This is based on SIC codes, and other publicly available class codes including: ISO general liability class codes (CGL); California Work Comp Codes (CA, WC); Delaware & Pennsylvania Work Comp Class Codes (DE, PA, WC); Michigan Work Comp Class Codes (MI, WC); New Jersey Work Comp Class Codes (NJ, WC); Texas Work Comp Class Codes (TX, WC); NCCI Work Comp Class Codes (all other states, except for the aforementioned that contain individual codes and monopolistic states, which are not open to commercial insurers—Nevada, North Dakota, Ohio, Washington, West Virginia) (NCCI); and NAICS class codes.

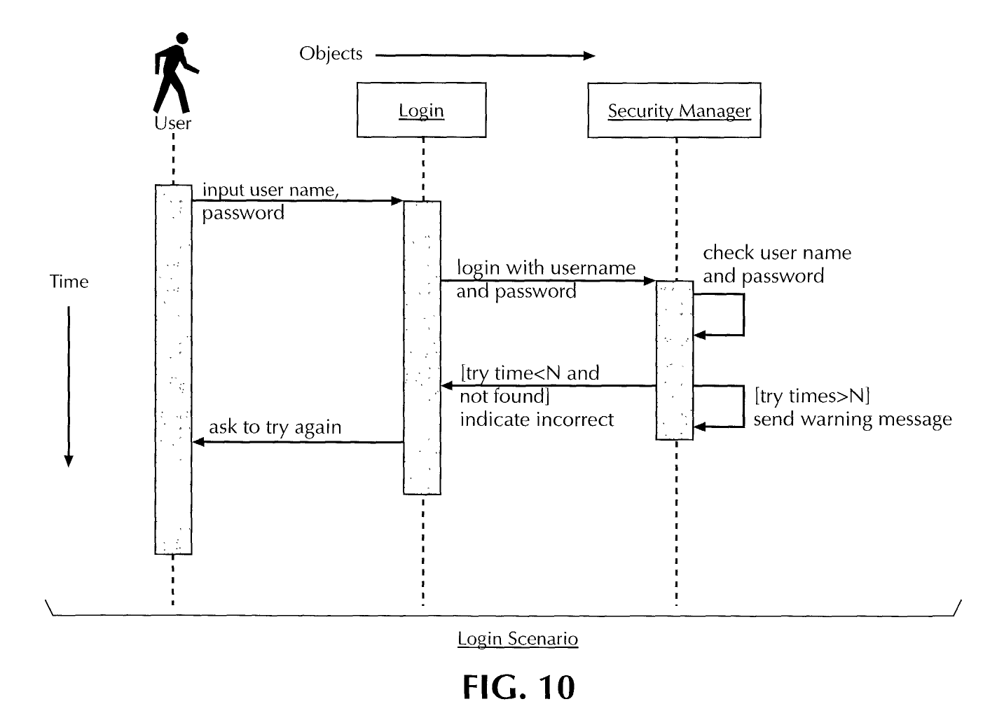

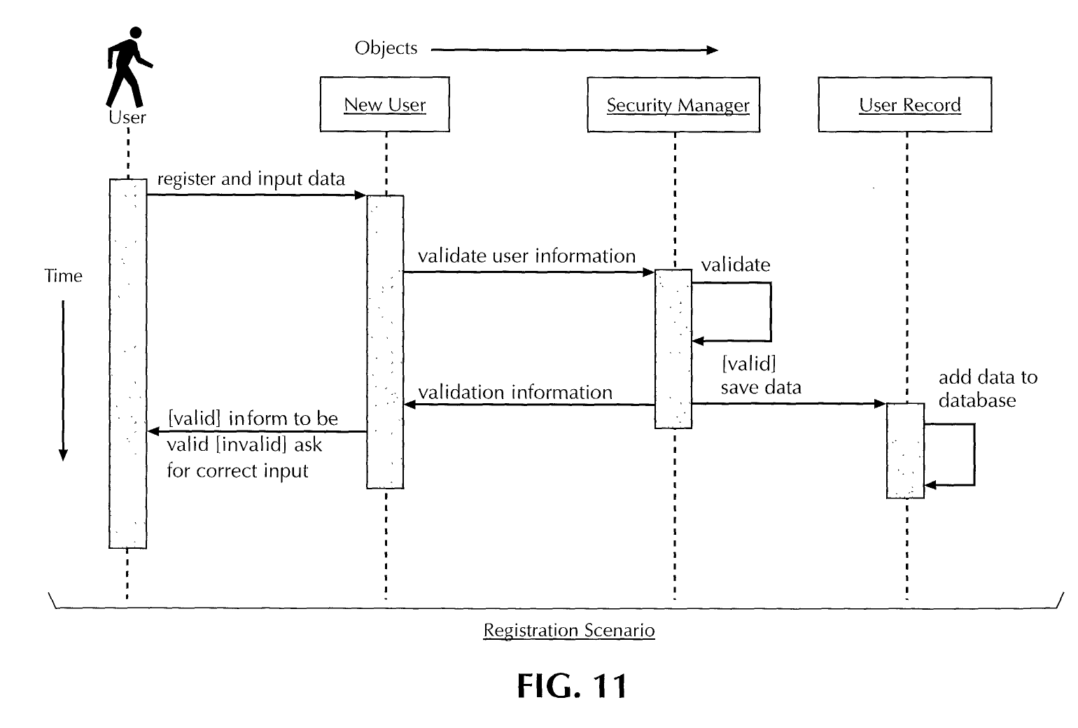

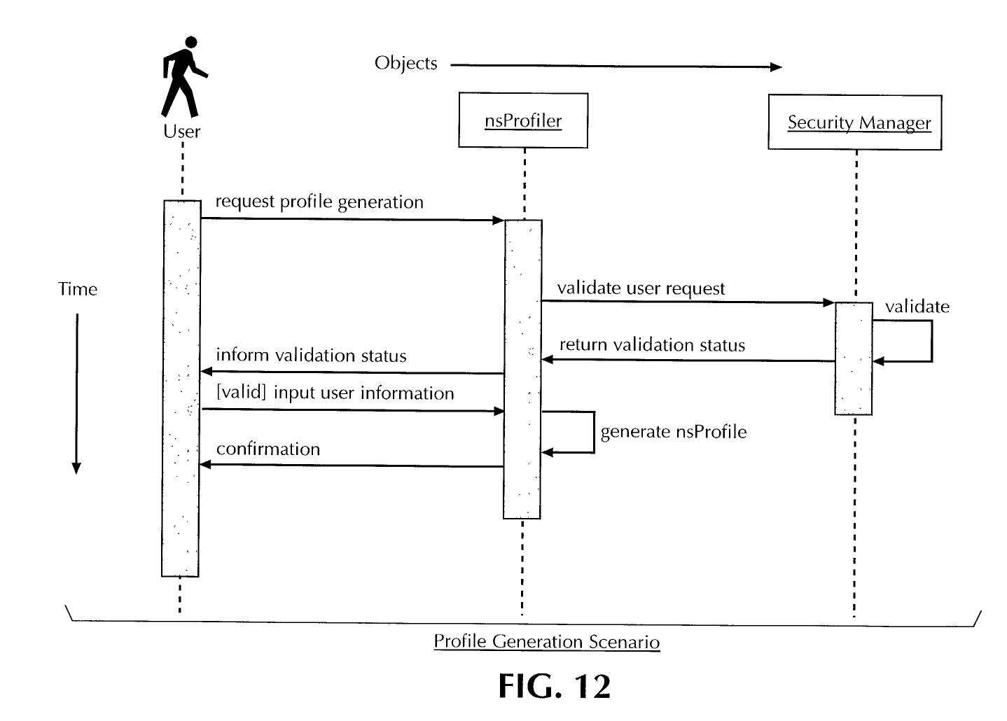

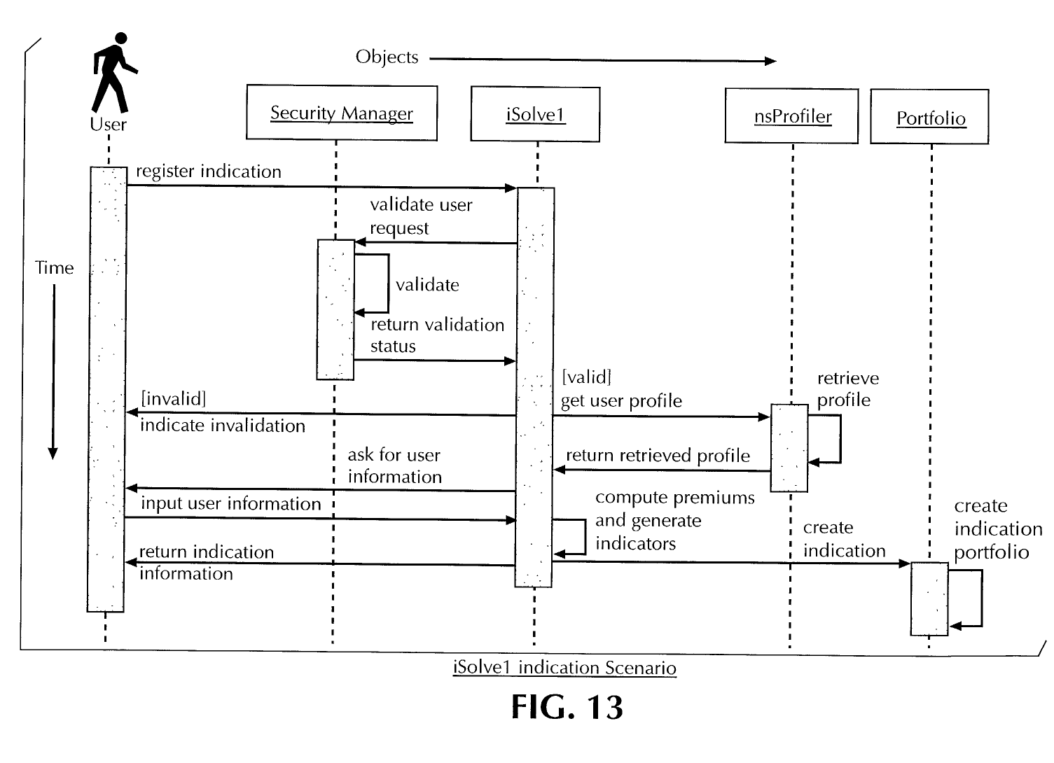

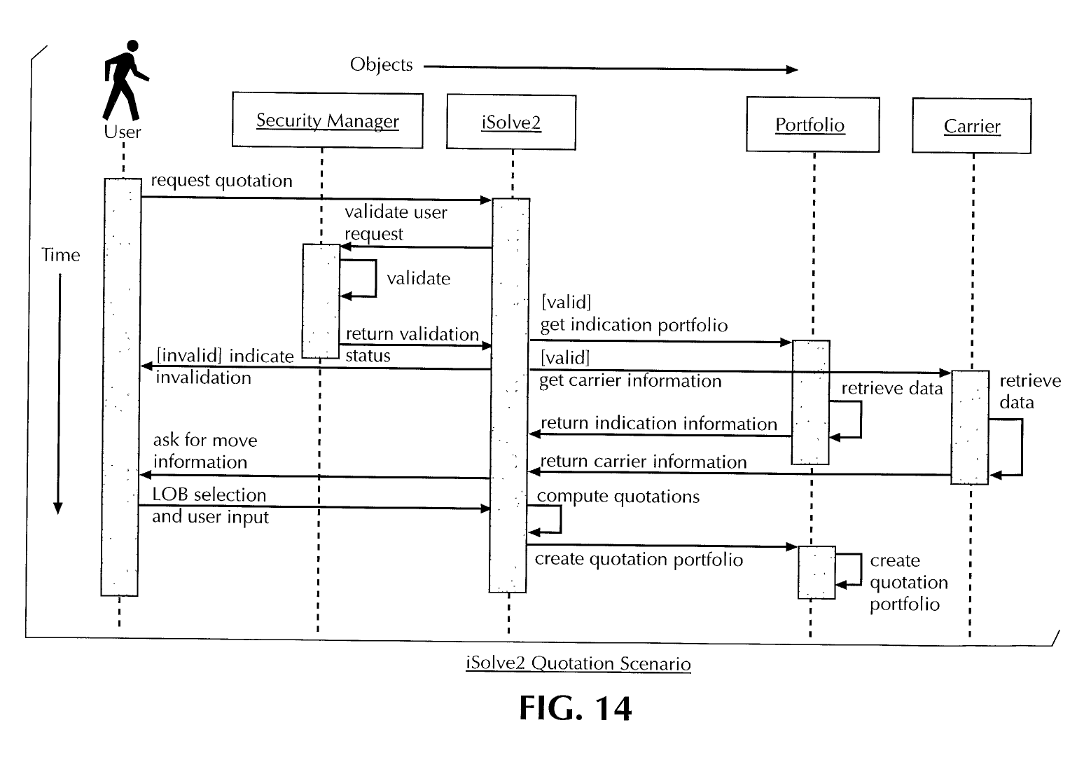

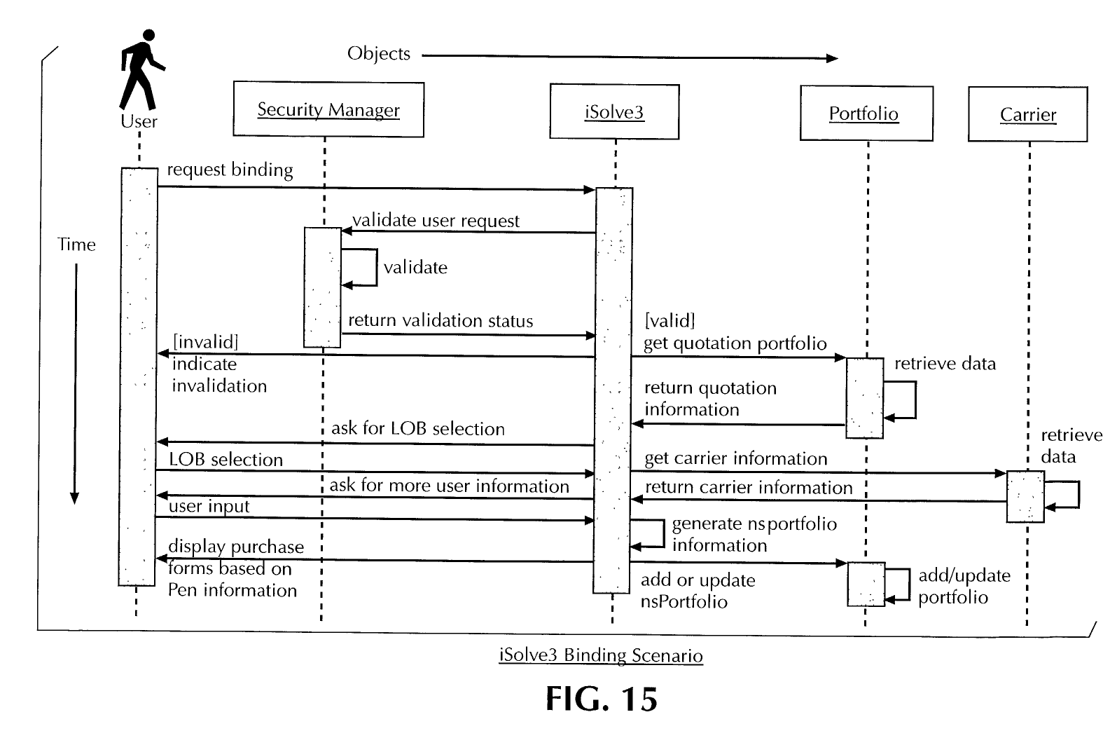

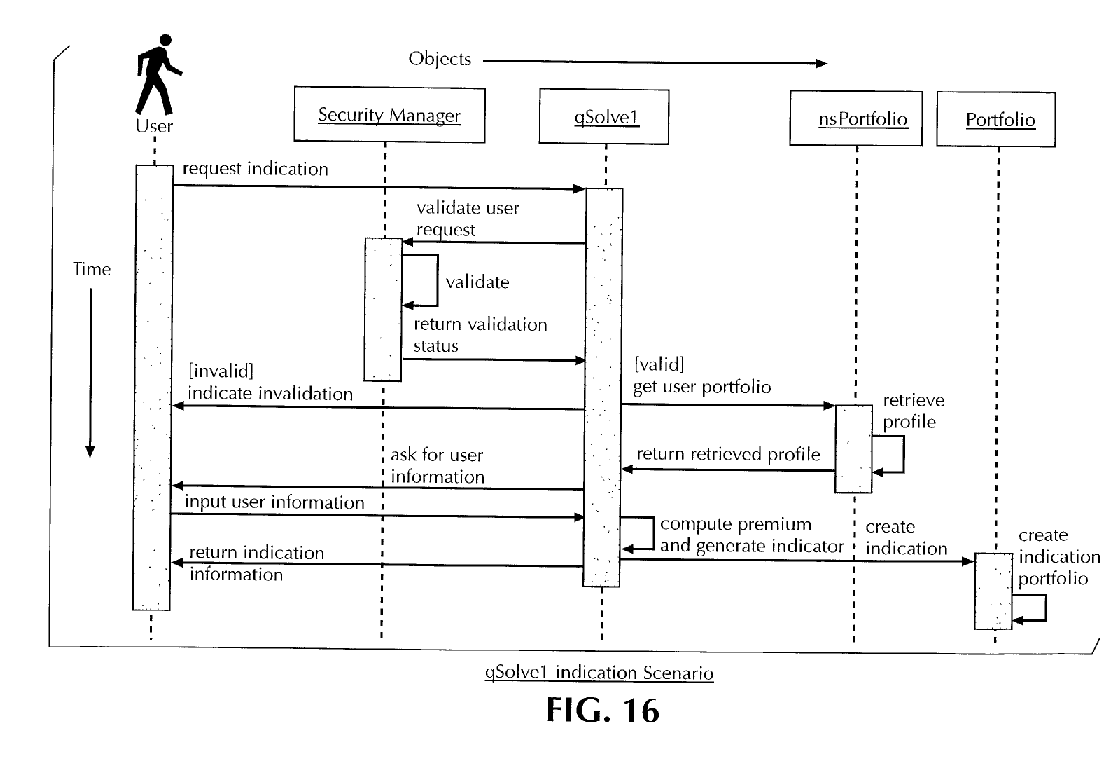

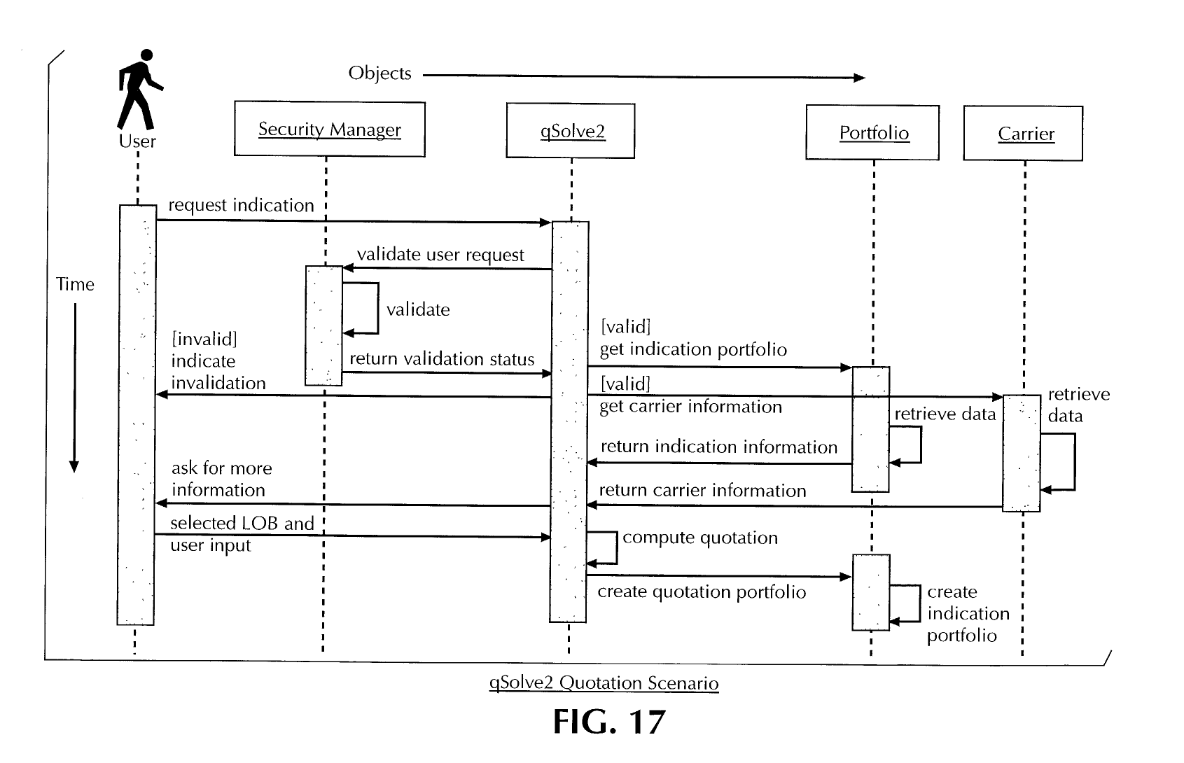

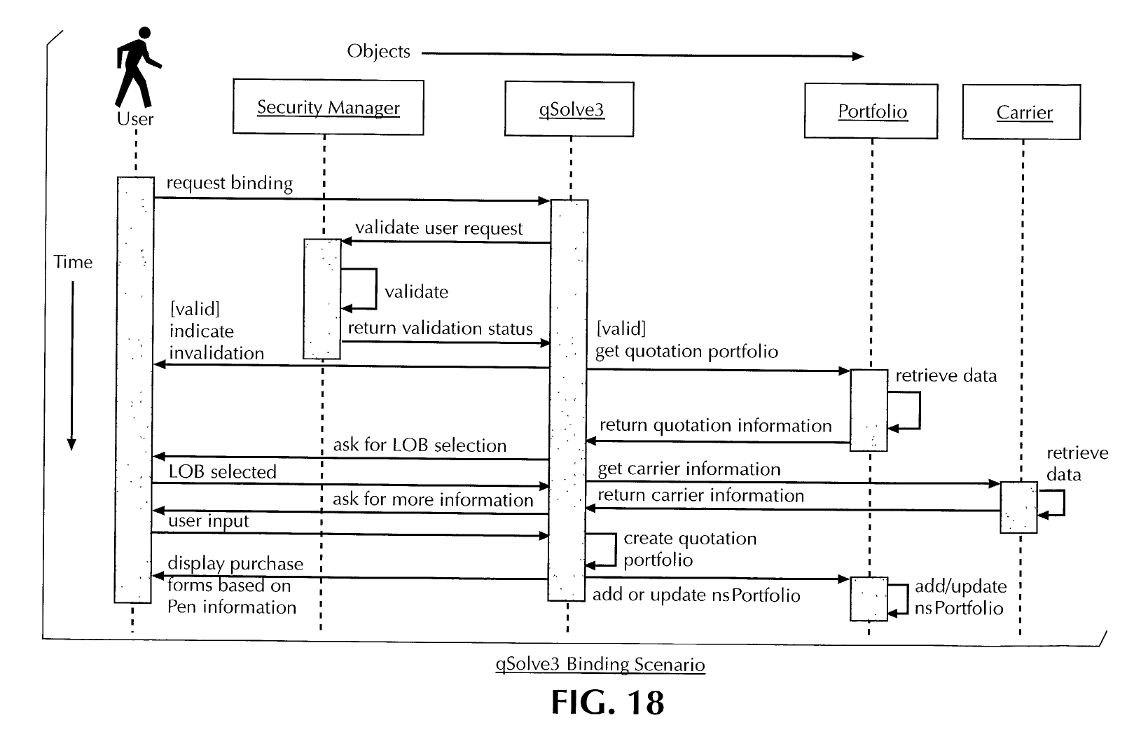

The nuServe processes described above correspond to many classes of objects. Objects can be considered as logical entities encapsulating attributes and procedures (or methods). Depending on the system logic, one object can invoke one or more methods from another object. Furthermore, execution of methods in one object can be conditional on messages received from other objects. Unless constrained by the functional design of the system, the objects will be non-synchronous providing a maximal permissive system. An object model provides a logical view of a system in terms of various operations, relations and attributes or data. A scenario defines a sequence of activities and the relationship between these activities and objects. Scenarios can be used for software code preparation in order to implement functioning of the process. Accordingly, FIGS. 10-18 are scenarios for the following steps of the nuServe process respectively Login; Registration; Profile Generation; iSolve1 processing; iSolve2 processing; iSolve3 processing; Qsolve1 processing; Qsolve2 processing, and Qsolve3 processing.

The invention has been described and illustrated in connection with certain preferred embodiments which illustrate the principals of the invention. However, it should be understood that various modifications and changes may readily occur to those skilled in the art, and it is not intended to limit the invention to the construction and operation of the embodiments shown and described herein. Accordingly, additional modifications and equivalents may be considered as falling within the scope of the invention as defined by the claims herein below.

What is claimed is:

1. A web based system maintained at a central server and accessible to users over the Internet for defining risk mitigation needs of a user based upon profile data of said user, comprising:
means for inputting said profile data to said system;
means for accumulating said data in databases to enable analysis of said data;
means for analyzing said profile data and for identifying financial risks associated with said profile data;
means for identifying financial products which provide solutions to such risks;
means for specifying the cost to acquire such financial products;
means for binding in real time a commitment for the purchase and sale of said financial products; and
means for processing a transaction to implement the purchase and sale of said financial products.

2. The web based system according to claim 1, wherein said means for analyzing said profile data and for identifying said financial products comprises a computing engine for computing financial product values, product prices or premiums, said computing engine comprising software for analyzing financial risk associated with said profile data and for identifying said financial products as solutions for mitigating said risks.

3. The web based system according to claim 2, wherein said means for specifying the cost to acquire said financial products comprises a quotation engine, said quotation engine comprising software for providing price or premium quotations for said financial products for a particular area of business activity.

4. The web based system according to claim 3, wherein said means for inputting said profile data comprises a graphical user interface displayed on a computer screen of a user, said graphical user interface accessible to said user over the Internet providing means for populating said databases.

5. The web based system according to claim 3, wherein said means for binding said commitment and for processing said transactions comprises web based links to Internet based sources for the sale of said financial products.

6. The web based system according to claim 5, wherein said financial products are insurance policies for insuring against defined risks.

7. The web based system according to claim 5, wherein said financial products are future contracts for a specified commodity.

8. The web based system according to claim 7, wherein said commodity is currency.

9. A system for defining risk mitigation needs of a user based upon profile data of said user, comprising: means for inputting said profile data to said system; means for accumulating said data in databases to enable analysis of said data; means for analyzing said profile data and for identifying financial risks and risk mitigation needs associated with said profile data; means for matching said risk mitigation needs with financial products that provide solutions to such risks; and means for processing a transaction to implement the purchase and sale of said financial products.

10. The system according to claim 9, wherein said means for analyzing said profile data and for identifying said financial products comprises a computing engine for computing financial product values, product prices or premiums.

11. The system according to claim 10, wherein said computing engine comprises software for analyzing financial risk associated with said profile data and for identifying said financial products as solutions for mitigating said risks.

12. The system according to claim 11, further comprising means for specifying the cost to acquire said financial products including a quotation engine, said quotation engine comprising software for providing price or premium quotations for said financial products for a particular area of business activity.

13. The system according to claim 12, wherein said means for inputting said profile data comprises a graphical user interface displayed on a computer screen of a user.

14. The system according to claim 13, further comprising means for binding a commitment for the purchase and sale of said financial products.

15. The system according to claim 14, wherein said financial products are insurance policies for insuring against defined risks.

16. The system according to claim 15, wherein said financial products are future contracts for a specified commodity.

17. The system according to claim 16, wherein said commodity is currency.

18. The system according to claim 14, wherein said system is a web based system maintained at a central server and accessible to users over the Internet.

19. The system according to claim 18, wherein said graphical user interface is accessible to said user over the Internet providing means for populating said databases.

20. The system according to claim 19, wherein said means for binding said commitment and for processing said transactions comprises web based inks to Internet based sources for the sale of said financial products.

21. A process for assessing and defining risk mitigation needs of a user in real time on line comprising:
accessing a web based processing system;
registering the user on said system from among a class of users;
inputting profile data indicative of said users financial and other characteristics to a profile engine on said system through a graphical user interface and saving said profile data in a database;
analyzing said profile data and identifying financial risks of said user as determined by said profile data;
identifying financial products to provide solutions to said financial risks; and
generating quotes for the cost for said user to acquire said identified financial products.

22. The process of claim 21, further comprising the steps of binding in real time a commitment for the purchase and sale of said financial products.

23. The process of claim 22, wherein said registering the user comprises the steps of entering registration data; validating said registration data; requiring reentry of said registration data if said data is not validated; and saving validated registration data in said database.

24. The process of claim 23, further comprising the steps of generating price and premium indicators based upon said profile data saved in said database and based upon ISO rates and lines of business stored in said database.

25. The process of claim 24, wherein said inputting said profile data comprises entering profile information relating to each line of business of said user by following entry fields as directed by pop-up icons on a display screen of said user.

26. The process of claim 25, further comprising the step of linking said profile data to a profiler page where said profile data is presented on said user's display screen.

27. The process of claim 26, wherein said lines of business are selected from the group consisting of: property and business income, crime coverage, fiduciary liability, general liability, boiler and machinery, errors and omission liability, commercial auto, employment practices liability, directors and officers liability, workers compensation, umbrella-excess liability, KNR, earthquake and flood, transit and ocean marine, cyber liability, environmental impairment liability and BOP.

28. The process of claim 22, wherein said analyzing said profile data and identifying financial risk comprise the generation of price and premium indicators based upon ISO rates and lines of business from said database, generating quotations based upon said indicators, and binding the purchase of said financial products to create a portfolio.

29. The process of claim 28, wherein said quotes are provided from said database.

30. The process of claim 29, wherein said quotes are provided by third-party insurance carriers.

31. The process of claim 28, further comprising the step of synchronizing said portfolio with said profile data and regenerating said indicators and quotations based upon said synchronized profile.

32. The process of claim 31, further comprising the step of synchronizing said indicators with said profile data and regenerating said indicators based on said synchronizing.

33. The process of claim 28, further comprising the step of inputting additional data to complete the step of binding.

34. The process of claim 33, further comprising the step of selecting financial products to purchase during said binding process based on said quotes.

35. The process of claim 34, further comprising the step of providing a contract page to said user upon binding the purchase of a financial product.

36. The process of claim 22, wherein said step of generating said quotes includes quoting the cost for a plurality of financial products.

37. The process of claim 22, wherein the step of generating said quotes includes quoting the cost for a single financial product.

38. The process of claim 22, wherein said step of binding for the purchase and sale of said financial products comprises the steps of entering additional data, selecting to purchase, policy portfolio generation and synchronizing said portfolio with said profile data entry.

39. The process of claim 22, further comprising the step of updating said profile data upon the users selection to bind the purchase of said financial products.

40. The process of claim 22, further comprising the step of comparing said portfolio with a user generated portfolio.

41. The process of claim 22, further comprising the steps of generating a binder form and generating a request for certificate of insurance form.

42. The process of claim 22, further comprising the steps of transferring data from said database to insurance carriers and/or insurance brokers and from insurance carriers and/or insurance brokers to said database.

43. The process of claim 42, wherein said step of data transfer is through browser based download.

44. The process of claim 42, wherein said step of data transfer is through specified protocols, including XML and/or http.

45. A process for assessing and defining risk mitigation needs of a user comprising:
accessing a processing system;
inputting profile data to a profile engine on said system through a graphical user interface, said profile data indicating said user's financial and business characteristics and saving said registration data in a database;
analyzing said profile and identifying financial risks of said user as determined by said profile; and
identifying financial products to provide solutions to said risks.

46. The process of claim 45, further comprising the steps of generating quotes for the cost for said user to acquire said identified financial products, and binding in real time a commitment for the purchase and sale of said financial products.

47. The process of claim 46, wherein said registering the user comprises the steps of entering registration data; validating said registration data; requiring reentry of said registration data if said data is not validated; and saving validated registration data in said database.

48. The process of claim 47, wherein said system is a web based system and accessing said system is over the Internet.

49. The process of claim 48, wherein said inputting said profile data comprises entering profile information relating to each line of business of said user by following entry fields as directed by pop-up icons on a display screen of said user.

50. The process of claim 49, further comprising the step of linking said profile data to a profiler page where said profile data is presented on said user's display screen.

51. The process of claim 50, wherein said step of binding in the real time a commitment for the purchase and sale of said financial products comprises the steps of entering additional data, selecting to purchase, policy portfolio generation and synchronizing said portfolio with said profile data entry.

52. The process of claim 51, further comprising the step of purchasing selected financial products.

53. The process of claim 52, wherein said step of purchasing comprises linking over the Internet through said system to providers of said financial products.
